(19) United States
(12) Patent Application Publication
(10) Pub. No.: US 2020/0325866 A1
(43) Pub. Date: Oct. 15, 2020

(54) HIGH-PRESSURE ACCUMULATOR AND METHOD FOR PRODUCING A HIGH-PRESSURE ACCUMULATOR

(71) Applicant: Robert Bosch GmbH, Stuttgart (DE)

(72) Inventors: Dietmar Uhlmann, Korb (DE); Giovanni Ferraro, Ludwigsburg (DE)

(21) Appl. No.: 16/305,664

(22) PCT Filed: Apr. 12, 2017
(86) PCT No.: PCT/EP2017/058845

§ 371 Date: Nov. 29, 2018

(30) Foreign Application Priority Data
May 31, 2016 (DE) 10 2016 209 423.8

(51) Int. Cl. F02M 55/02; F02M 55/04

(52) U.S. Cl. CPC F02M 55/025; F02M 55/04; B33Y 80/00; F02M 2200/80; F02M 2200/315; F02M 2200/40

(57) ABSTRACT

The invention relates to a high-pressure accumulator (1) for internal combustion engines for storing highly pressurized fuel. The high-pressure accumulator (1) comprises an accumulator pipe (2) with an accumulator chamber (3) formed in the accumulator pipe (2). The high-pressure accumulator (1) comprises a supply connection (7) for supplying highly pressurized fuel and at least one discharge connection (4) for discharging highly pressurized fuel. A honeycomb structure (10) is arranged in the accumulator chamber (3).

### BACKGROUND OF THE INVENTION

The present invention relates to a high pressure accumulator, in particular for an injection system of an internal combustion engine. Furthermore, the invention relates to a method for producing a high pressure accumulator of this type.

The invention relates to a high pressure accumulator, in particular for an injection system for injecting fuel at high pressure into the combustion chamber of an internal combustion engine, and to a method for producing a high pressure accumulator of this type.

High pressure accumulators are known from the prior art, for example from DE 10 2008 040 901 A1. The known high pressure accumulator has an accumulator space for storing highly pressurized fuel. Furthermore, there are also receptacles for attachment components in addition to the pump-side and injector-side connectors. Here, the two attachment components of the rail pressure sensor and the pressure control valve or pressure limiting valve are usually attached to the high pressure accumulator.

The injection system, in particular the high pressure accumulator and the injectors, are sensitive to pressure oscillations insofar as the latter reduce the service life of the components which are loaded with them.

### SUMMARY OF THE INVENTION

In contrast, the high pressure accumulator according to the invention for internal combustion engines has reduced loading and accordingly a longer service life.

To this end, the high pressure accumulator comprises a common rail with an accumulator space which is configured in the common rail. The high pressure accumulator has a feed connector for feeding in highly pressurized fuel and at least one discharge connector for discharging highly pressurized fuel. A honeycomb structure is arranged in the accumulator space.

The honeycomb structure acts as a throttle in the case of a rapid throughflow of the accumulator space, as occurs in the case of open discharge connectors for instance, and therefore damps pressure oscillations in the accumulator space, but also in the components which are connected downstream of the discharge connectors, for example injectors for injecting fuel into the internal combustion engine. The pressure loading of the components is reduced and therefore the service life of the components is increased by way of the damping of the pressure overshoots. Furthermore, the honeycomb structure can also be designed in such a way that it stiffens the common rail and increases the strength of the high pressure accumulator as a result.

In advantageous refinements, the common rail and the honeycomb structure are configured in one piece. As a result, complicated connecting techniques can be dispensed with, and the high pressure accumulator is of particularly rigid configuration. The high pressure accumulator is produced using the 3D printing process; a conventional casting process is not suitable for this purpose.

In one advantageous development, the honeycomb structure comprises at least one, but preferably from 10 to 15 disks, a plurality of honeycomb-shaped recesses being configured in each disk. As a result, the fuel flow through the individual disks is damped. Pressure waves are reflected partially on the disks and are superimposed in such a way that the pressure overshoots are attenuated.

The disks are advantageously lined up one after another in each case at the same axial spacing. As a result, the throttle points are arranged at identical spacings in the axial direction of the accumulator space. The pressure oscillations in the accumulator space are thus damped uniformly.

In advantageous embodiments, the recesses have the basic shape of a regular hexagon. This is a particularly favorable throttle geometry with a comparatively low weight. For comparison purposes, circular bores do not have a constant web width between the bores and accordingly require high material buildups locally.

The edge length of the regular hexagon is advantageously 0.75 mm. This is very suitable, in particular, for a diameter of the substantially cylindrical accumulator space of approximately 10 mm.

In advantageous alternative embodiments, the honeycomb structure comprises at least one, but preferably from 10 to 15 honeycomb cups. A plurality of honeycomb-shaped recesses are configured in each honeycomb cup. As a result, the fuel flow is damped through the individual honeycomb cups which act as throttle points. Pressure waves are reflected partially on the honeycomb cups and are superimposed in such a way that the pressure overshoots are attenuated. The fuel flow through the accumulator space can be steered in a very controlled manner by way of the honeycomb cups.

Each honeycomb cup advantageously has a head region, the diameter of which corresponds to the diameter of the accumulator space, and is preferably approximately 10 mm. Furthermore, each honeycomb cup has a tapered base region. Here, the tapered portion along the axial axis can run in a conical or curved manner. Here, the cup shape is a very satisfactory compromise between satisfactory flow guidance, a satisfactory damping function, a high rigidity and a low weight.

In advantageous developments, the honeycomb cups are arranged in such a way that in each case a head region interacts with a head region of the next honeycomb cup and, correspondingly, a base region interacts with a base region of the adjacent honeycomb cup. As a result, the honeycomb cups are arranged in series in such a way that pronounced damping of pressure oscillations takes place in the case of a throughflow of the two head regions which are arranged next to one another. Furthermore, the rigidity of the high pressure accumulator is also increased considerably in the axial direction by way of an arrangement of this type.

In advantageous embodiments, the honeycomb cups have a length of 5 mm. As a result, the throttle points by way of the head regions are arranged at identical spacings in the axial direction of the accumulator space. The pressure oscillations in the accumulator space are thus damped uniformly.

In advantageous embodiments, the recesses have the basic shape of a regular hexagon. This is a particularly favorable throttle geometry with a comparatively low weight. For comparison purposes, circular bores do not have a constant web width between the bores and accordingly require high material buildups locally.

The edge length of the regular hexagon is advantageously 0.75 mm. This is very suitable, in particular, for a diameter of the accumulator space of approximately 10 mm.

The production of the above-described high pressure accumulators takes place using the 3D printing process which makes the manufacture of geometries of this type inexpensive in the first place. In particular, the single-piece embodiment of the common rail and the honeycomb structure is then particularly advantageous, namely is firstly very inexpensive and secondly has a high rigidity.

### BRIEF DESCRIPTION OF THE DRAWINGS

In the following text, exemplary embodiments of the invention will be described in greater detail with reference to the appended drawings, in which:

FIG. 1 diagrammatically shows a high pressure accumulator in longitudinal section, as is known from the prior art,

FIG. 2 shows a detail of a half-model of a high pressure accumulator according to the invention in a perspective view, only the essential regions being shown, and

FIG. 3 shows a detail of a further high pressure accumulator according to the invention as a half-model in a perspective view, only the essential regions being shown.

### DETAILED DESCRIPTION

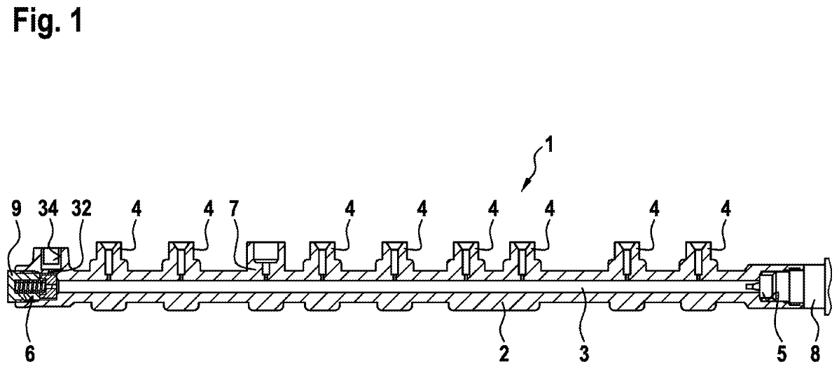

In the longitudinal section of FIG. 1, 1 denotes a tubular high pressure accumulator, as is known from the prior art. The high pressure accumulator 1 has a common rail 2 which surrounds an accumulator space 3. The high pressure accumulator 1 is provided for an injection system for internal combustion engines and is usually also called a rail.

A plurality of discharge connectors 4 for fuel pressure lines to injectors (not shown) are configured on the common rail 2 of the high pressure accumulator 1. Furthermore, a feed connector 7 to a high pressure pump (not shown) is configured on the common rail 2. In addition, receptacles 5 and 6 for attachment components 8 and 9 are configured on the common rail 2. The attachment component 8 is usually a rail pressure sensor for determining the pressure in the accumulator space 3. In addition, the attachment component 9 is a pressure valve, preferably a pressure control valve for controlling the pressure in the accumulator space 3. The pressure valve 9 or pressure control valve 9 is configured, for example, as an electromagnetic valve and has an electric connector (not shown) for connecting to a control unit or a power supply (not shown).

The receiving opening 6 for the pressure valve 9 is connected via an outlet duct 32 to a low pressure connector 34, with the result that a fuel quantity which is output in a controlled manner via the pressure valve 9 can be guided to a low pressure return line. Here, the outlet duct 32 opens into the receiving opening 6 in such a way that a seal is ensured between the high pressure part and the low pressure part (outlet duct 32) in the case of a pressure valve 9 which is attached to the high pressure accumulator 1.

In the exemplary case, the pressure valve 9 and the rail pressure sensor 8 are arranged at ends of the high pressure accumulator 1 which face away from one another. Here, the distribution of said attachment components 8, 9 on the high pressure accumulator 1 is in principle freely selectable.

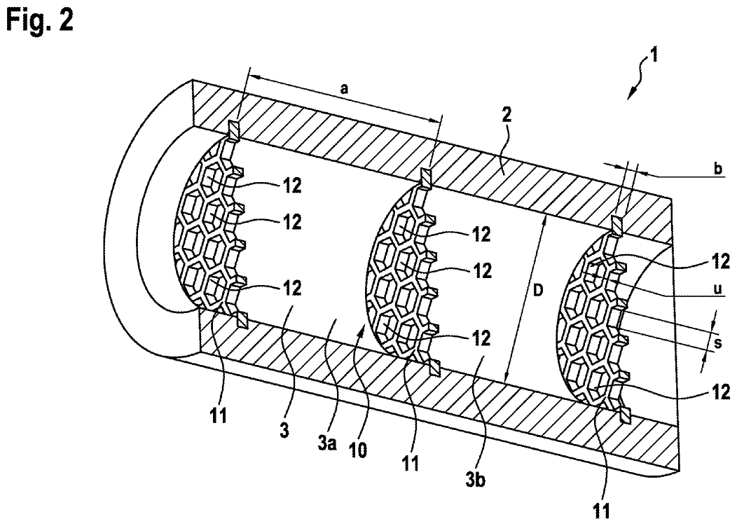

FIG. 2 shows a section of a high pressure accumulator 1 according to the invention in a longitudinally sectioned manner in a perspective view. The high pressure accumulator 1 is suitable, in particular, for a fuel injection system, for example a common rail system. Fuel is conveyed at high pressure from a high pressure pump (not shown) via the feed connector (not shown) into the high pressure accumulator 1, from where it is distributed via the discharge connectors (not shown) to injectors (not shown) for injecting into the combustion chambers of internal combustion engines.

The high pressure accumulator 1 has the common rail 2, in which the accumulator space 3 for storing the highly pressurized fuel is configured. Flow conditions of the fuel in the accumulator space 3 which are dependent on the operating point are produced with pressure oscillations on account of the feeding of the fuel from the high pressure pump and the discharge of the fuel to the injectors.

A honeycomb structure 10 is arranged in the accumulator space 3 in order to damp said pressure oscillations. In the embodiment of FIG. 2, the honeycomb structure 10 has a plurality of disks 11 which are spaced apart axially from one another and in which in turn in each case a plurality of honeycomb-shaped recesses 12 are configured. Here, the disks 11 are preferably arranged at a spacing a of at least 5 mm from one another and have a thickness b of 0.5 mm. Furthermore, the honeycomb-shaped recesses 12 in each case have the shape of a uniform hexagon with an edge length s of 0.75 mm in a manner which is advantageous for an accumulator space 3 with a diameter D of approximately 10 mm. Here, the web width u of the honeycomb structure 10 between the individual recesses 12 is preferably 0.55 mm.

The accumulator space 3 is divided by way of the disks 11 into individual chambers 3a, 3b, etc., which are connected to one another via the cross-sectional reduction by way of the honeycomb-shaped recesses 12. Accordingly, the honeycomb-shaped recesses 12 represent throttles in the axial flow direction which effectively damp any pressure overshoots during the throughflow. As a result, the maximum pressure peaks within the high pressure accumulator 1 and also within the downstream injectors are damped. Accordingly, the service life of said components is increased.

The common rail 2 and the honeycomb structure 10 are advantageously configured in one piece, with the result that a complicated connecting technique is not required. The corresponding production process to this end is preferably the 3D printing process; a conventional casting process is not suitable for geometries of this type in high quantities.

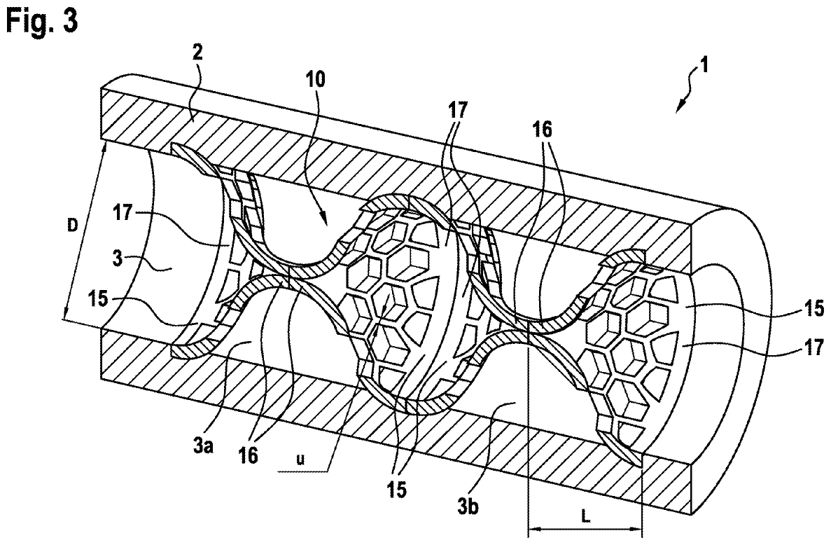

FIG. 3 shows a further exemplary embodiment of the high pressure accumulator 1 with a honeycomb structure 10 in a half-model in a perspective view, only the essential regions being shown. The honeycomb structure 10 of said embodiment comprises honeycomb cups 15 which are lined up axially next to one another and are in each case of cup-shaped design with a wide head region 17 and a greatly tapered base region 16. Here, the individual honeycomb cups 15 are lined up next to one another in such a way that a base region 16 always interacts with another base region 16 of the next honeycomb cup 15, and a head region 17 always interacts with the next head region 17. At the respective ends of the accumulator space 3, the base regions 16 or head regions 17 there are supported on a corresponding shoulder or an end face of the common rail 2.

On account of the positively locking lining up of the individual honeycomb cups 15, the honeycomb structure 10 in said embodiment has a high rigidity and thus also increases the strength of the common rail 2 or the entire high pressure accumulator 1, both in the radial and in the axial direction. The individual honeycomb cups 15 preferably have a length L of 5 mm, from 10 to 15 honeycomb cups 15 advantageously being lined up in the accumulator space 3. Furthermore, the honeycomb-shaped recesses 12 in each case have the shape of a uniform hexagon with an edge length s of 0.75 mm, in a manner which is advantageous for an accumulator space 3 with a diameter D of approximately 10 mm. Here, the web width u of the honeycomb structure 10 between the individual recesses 12 is preferably 0.55 mm.

In general, a very complex geometry of the honeycomb structure 10 can be realized using the 3D printing process, specifically if the honeycomb structure 10 is configured in one piece with the common rail 2. Here, the above-described embodiments prove particularly effective for damping the pressure oscillations in the accumulator space 3, caused by way of the periodic conveying of highly pressurized fuel from the high pressure pump via the feed connector 7 and the sudden discharge of fuel via one or more discharge connectors 4 to the injectors.

1. A high pressure accumulator (1) for internal combustion engines for storing highly pressurized fuel, the high pressure accumulator (1) comprising a common rail (2) with an accumulator space (3) which is configured in the common rail (2), the high pressure accumulator (1) having a feed connector (7) for feeding in highly pressurized fuel and at least one discharge connector (4) for discharging highly pressurized fuel, characterized in that a honeycomb structure (10) is arranged in the accumulator space (3).

2. The high pressure accumulator (1) as claimed in claim 1, characterized in that the common rail (2) and the honeycomb structure (10) are configured in one piece.

3. The high pressure accumulator (1) as claimed in claim 1, characterized in that the honeycomb structure (10) comprises at least one disk (11), a plurality of honeycomb-shaped recesses (12) being configured in the disk (11).

4. (canceled)

5. The high pressure accumulator (1) as claimed in claim 3, characterized in that the recesses (12) have the basic shape of a regular hexagon.

6. The high pressure accumulator (1) as claimed in claim 5, characterized in that an edge length (s) of the regular hexagon is 0.75 mm.

7. The high pressure accumulator (1) as claimed in claim 1, characterized in that the honeycomb structure (10) comprises at least one honeycomb cup (15), a plurality of honeycomb-shaped recesses (12) being configured in the honeycomb cup (15).

8. The high pressure accumulator (1) as claimed in claim 7, characterized in that each honeycomb cup (15) has a head region (17), a diameter of which corresponds to a diameter of the accumulator space (3), and wherein each honeycomb cup (15) has a tapered base region (16).

9. (canceled)

10. The high pressure accumulator (1) as claimed in claim 7, characterized in that the honeycomb cups (15) have a length (L) of 5 mm.

11. The high pressure accumulator (1) as claimed in claim 7, characterized in that the recesses (12) have a basic shape of a regular hexagon.

12. The high pressure accumulator (1) as claimed in claim 11, characterized in that an edge length of each regular hexagon is 0.75 mm.

13. A method for producing a high pressure accumulator (1) as claimed in claim 1, the common rail (2) and the honeycomb structure (10) being configured in one piece, characterized in that the high pressure accumulator (1) is manufactured using the 3D printing process.

14. The high pressure accumulator (1) as claimed in claim 1, characterized in that the honeycomb structure (10) comprises from 10 to 15 disks (11), a plurality of honeycomb-shaped recesses (12) being configured in each disk (11).

15. The high pressure accumulator (1) as claimed in claim 14, characterized in that the disks (11) are lined up one after another in each case at the same axial spacing (a).

16. The high pressure accumulator (1) as claimed in claim 14, characterized in that the recesses (12) have the basic shape of a regular hexagon.

17. The high pressure accumulator (1) as claimed in claim 16, characterized in that an edge length (s) of the regular hexagon is 0.75 mm.

18. The high pressure accumulator (1) as claimed in claim 1, characterized in that the honeycomb structure (10) comprises from 10 to 15 honeycomb cups (15), a plurality of honeycomb-shaped recesses (12) being configured in each honeycomb cup (15).

19. The high pressure accumulator (1) as claimed in claim 18, characterized in that each honeycomb cup (15) has a head region (17), a diameter of which corresponds to a diameter of the accumulator space (3), and wherein each honeycomb cup (15) has a tapered base region (16).

20. The high pressure accumulator (1) as claimed in claim 19, characterized in that the honeycomb cups (15) are arranged in such a way that in each case a head region (17) interacts with a head region (17) and a base region (16) interacts with a base region (16).

21. The high pressure accumulator (1) as claimed in claim 18, characterized in that the honeycomb cups (15) have a length (L) of 5 mm.

22. The high pressure accumulator (1) as claimed in claim 18, characterized in that the recesses (12) have a basic shape of a regular hexagon.

23. The high pressure accumulator (1) as claimed in claim 22, characterized in that an edge length of each regular hexagon is 0.75 mm.
